(19) United States
(12) Patent Application Publication
(10) Pub. No.: US 2024/0204305 A1
(43) Pub. Date: Jun. 20, 2024

(54) SECONDARY BATTERY AND ELECTRONIC APPARATUS

(71) Applicant: Dongguan Amperex Technology Limited, Dongguan (CN)

(72) Inventor: Chenchen LI, Dongguan (CN)

(73) Assignee: Dongguan Amperex Technology Limited, Dongguan, GD (CN)

(21) Appl. No.: 18/539,288

(22) Filed: Dec. 14, 2023

(30) Foreign Application Priority Data
Dec. 15, 2022 (CN) 202211617174.3

(51) Int. Cl. H01M 50/102; H01M 50/119; H01M 50/133

(52) U.S. Cl. CPC H01M 50/102; H01M 50/119; H01M 50/133

(57) ABSTRACT

A secondary battery includes an electrode assembly, a housing, and an adhesion layer. The housing includes an upper housing body and a lower housing body. The lower housing body is provided with a recess for accommodating the electrode assembly. The upper housing body is configured to cover the recess. The adhesion layer is provided on a bottom surface of the recess opposite to the upper housing body. The housing is a metal housing. The adhesion layer adheres the electrode assembly to the housing.

### CROSS-REFERENCE TO RELATED APPLICATION

The present application claims priority to Chinese Patent Application No. 202211617174.3, filed on Dec. 15, 2022, the content of which is incorporated herein by reference in its entirety.

### TECHNICAL FIELD

This application relates to the field of electrochemical technologies, and in particular, to a secondary battery and an electronic apparatus.

### BACKGROUND

Secondary batteries (such as lithium-ion batteries) have advantages such as high energy storage density, high open-circuit voltage, low self-discharge rate, long cycle life, and high safety, and therefore are widely used in the fields such as portable electrical energy storage, electronic devices, and electric vehicles. During rapid development of lithium-ion batteries, higher requirements are imposed on comprehensive performance of the lithium-ion batteries.

In the actual use of a lithium-ion battery, there are special scenarios such as drops or collision causing direct contact between a metal housing and an electrode assembly of the lithium-ion battery, which increases a risk of short-circuit of the lithium-ion battery, thus leading to thermal runaway or even fire and failure, affecting safety performance of the lithium-ion battery. In the prior art, an insulating adhesive is typically applied between the metal housing and the electrode assembly to achieve an insulation effect. However, the amount of adhesive applied in this way is too large, which affects energy density of the battery and features high production costs, and the insulation effect of the adhesive is poor, which is not conducive to the safety performance of the lithium-ion battery.

### SUMMARY

This application is intended to provide a secondary battery and an electronic apparatus, so as to improve safety performance and energy density of the secondary battery and reduce production costs of the secondary battery.

It should be noted that in the summary of this application, a lithium-ion battery is used as an example of a secondary battery to explain this application, but not as a limitation on a type of the secondary battery. Specific technical solutions are as follows.

A first aspect of this application provides a secondary battery including an electrode assembly, a housing, and an adhesion layer, where the housing includes an upper housing body and a lower housing body, the lower housing body is provided with a recess for accommodating the electrode assembly, the upper housing body is configured to cover the recess, the adhesion layer is provided on a bottom surface of the recess opposite to the upper housing body, the housing is a metal housing, for example, a steel housing or an aluminum housing, and the adhesion layer adheres the electrode assembly to the housing. The adhesion layer in the secondary battery of this application adheres the electrode assembly to the housing, which not only provides buffering, reduces the possibility of contact between the electrode assembly and the housing during dropping, and reduces a risk of short-circuit of the secondary battery, but also facilitates alleviation of the tab connection failure caused by movement of the electrode assembly inside the housing, thereby improving safety performance of the secondary battery. In addition, the use of insulating adhesive paper is reduced, which can increase energy density of the secondary battery and reduce production costs of the secondary battery.

In some embodiments of this application, the adhesion layer is further provided on a surface of an inner side wall of the recess. Such structure is arranged to provide buffering, reduce the possibility of contact between the electrode assembly and the inner side wall of the recess during dropping, and reduce a risk of short-circuit of the secondary battery, thereby improving the safety performance of the secondary battery.

In some embodiments of this application, the upper housing body is plate-shaped, and the adhesion layer is further provided on an inner surface of the upper housing body. Such structure is arranged to provide buffering, reduce the possibility of contact between the electrode assembly and the upper housing body during dropping, and reduce a risk of short-circuit of the secondary battery, thereby improving the safety performance of the secondary battery.

In some embodiments of this application, when viewed from a thickness direction of the secondary battery, a distance from an edge of the adhesion layer to a corresponding outer side edge of the upper housing body or the lower housing body is 6 mm to 10 mm. The distance L from the edge of the adhesion layer to the corresponding outer side edge of the upper housing body or the lower housing body being controlled within the above range can improve the safety performance of the secondary battery.

In some embodiments of this application, the adhesion layer includes an aqueous binder; and the aqueous binder includes a copolymer of a first monomer and a second monomer, where the first monomer includes at least one of ethyl methacrylate, butyl acrylate, or 2-ethylhexyl acrylate, and the second monomer includes at least one of styrene, acrylonitrile, or vinyl acetate. Selection of the aqueous binder produced by copolymerization of the first monomer and second monomer of the above types is more conducive to improving the safety performance of the secondary battery.

In some embodiments of this application, a mass ratio of the first monomer to the second monomer is 1:1.0 to 1:1.5. The mass ratio of the first monomer to the second monomer being controlled within the above range can improve the safety performance of the secondary battery.

In some embodiments of this application, the adhesion layer further includes an additive, and the additive includes at least one of a plasticizer, a thickener, or a dispersant. Selection of the additive of the above types can improve the safety performance of the secondary battery.

In some embodiments of this application, the adhesion layer includes an oily binder, and the oily binder includes at least one of polyacrylic acid, polyvinylidene fluoride, polymethyl acrylate, polyethylene acrylate, poly-2-methyl methacrylate, poly-2-ethyl methacrylate, styrene acrylate copolymer, polyacrylonitrile, polyacrylamide, polyimide, or polyamide. The adhesion layer prepared using the oily binder selected from the above types can improve the safety performance of the secondary battery.

In some embodiments of this application, thickness of the adhesion layer is 5 μm to 20 μm. The thickness of the adhesion layer being controlled within the above range can increase the energy density of the secondary battery on the basis of improving the safety performance of the secondary battery.

In some embodiments of this application, adhesion force of the adhesion layer after soaking in a test electrolyte is 50 N/m to 200 N/m, indicating that the adhesion layer has desirable adhesion force.

In some embodiments of this application, the secondary battery is special-shaped, for example, L-shaped or H-shaped. When the adhesion layer is applied in the special-shaped battery, the production costs thereof can be further reduced.

A second aspect of this application provides an electronic apparatus including the secondary battery according to the first aspect of this application. Therefore, the electronic apparatus has good safety performance.

Certainly, implementing any product or method of this application does not necessarily require all the advantages described above.

### BRIEF DESCRIPTION OF DRAWINGS

To describe the technical solutions in some embodiments of this application or in the prior art more clearly, the following briefly describes the accompanying drawings required for describing the embodiments or the prior art. Apparently, the accompanying drawings described below show merely some embodiments of this application, and persons of ordinary skill in the art may still derive other embodiments from the accompanying drawings.

FIG. 1 is a schematic diagram of a positional relationship of an adhesion layer provided on a bottom surface of a lower housing body according to some embodiments of this application;

FIG. 2 is a schematic structural cross-sectional view in direction A-A in FIG. 1; and

FIG. 3 is a schematic diagram of a positional relationship of an adhesion layer provided on an inner surface of an upper housing body according to some embodiments of this application.

### DETAILED DESCRIPTION

The following clearly and completely describes the technical solutions in some embodiments of this application with reference to the accompanying drawings in some embodiments of this application. Apparently, the described embodiments are only some but not all embodiments of this application. All other embodiments obtained by persons of ordinary skill in the art based on some embodiments of this application shall fall within the protection scope of this application.

It should be noted that, in some specific embodiments of this application, a lithium-ion battery is used as an example of a secondary battery to explain this application, but not as a limitation on a type of the secondary battery. Specific technical solutions are as follows.

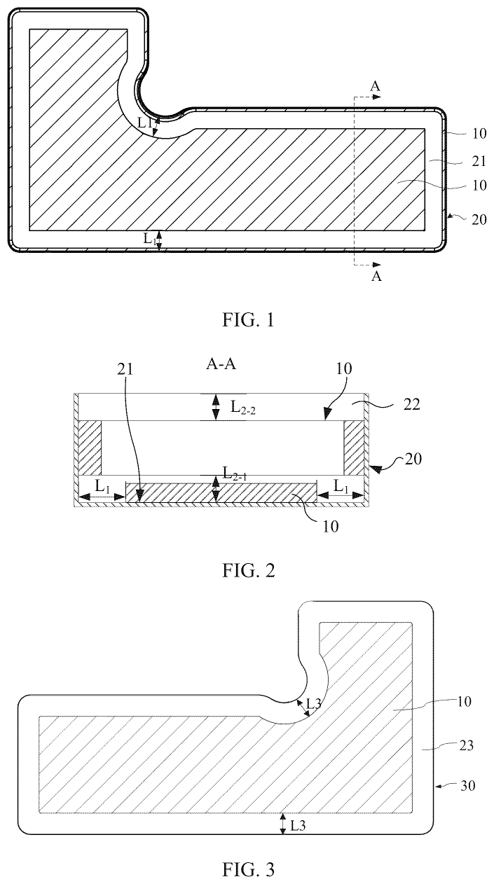

A first aspect of this application provides a secondary battery including an electrode assembly, a housing, and an adhesion layer, where the housing includes an upper housing body and a lower housing body, the lower housing body is provided with a recess for accommodating the electrode assembly, the upper housing body is configured to cover the recess, the adhesion layer is provided on a bottom surface of the recess opposite to the upper housing body, the housing is a metal housing, for example, a steel housing or an aluminum housing, and the adhesion layer adheres the electrode assembly to the housing. For example, FIG. 1 is a schematic diagram of a positional relationship of an adhesion layer provided on a bottom surface of a lower housing body according to some embodiments of this application. The adhesion layer 10 is provided on the bottom surface 21 of a recess for accommodating an electrode assembly in the lower housing body 20. Provision of the adhesion layer on the bottom surface of the recess allows the electrode assembly accommodated in the recess to be adhered to a bottom surface of the recess, so that the electrode assembly is adhered to the housing, and the electrode assembly and the housing form an integrated structure. In this way, not only can the adhesion layer provide buffering, so that when the secondary battery is subjected to drop, collision, or the like, a probability that a head, connected to a tab, of the electrode assembly impacts on the housing due to inertia is reduced, reducing a possibility of contact between the electrode assembly and the housing during dropping, thus reducing a risk of short-circuit of the secondary battery, but also as compared with the adhesive application manner in the prior art, the adhesion layer and the electrode assembly can achieve a larger adhesion area, so as to reduce a risk of tab connection failure caused by movement of the electrode assembly inside the housing. As a result, the safety performance of the secondary battery is improved. Moreover, provision of the adhesion layer can replace the use of winding adhesive with an insulation effect in the prior art, providing a good insulation effect. In the prior art, thickness of winding adhesive paper is about 20 μm, and thickness of hot-melt adhesive paper is about 25 μm, and application of the winding adhesive paper and hot-melt adhesive paper on two sides of an electrode assembly causes a loss, of about 50 μm, of volumetric energy density of a secondary battery in overall thickness. The provision of the adhesion layer realizes adhesion and insulation effects, featuring the effects of both hot-melt adhesive with adhesion function and winding adhesive in the prior art, and the application process of the adhesion layer is also simpler compared with the adhesive application process. Thus, on the basis of improving the safety performance of the secondary battery, the energy density thereof is also increased, and the production costs thereof are reduced.

In this embodiment of this application, hardness HRB of the housing is greater than or equal to 90, and the housing is made of metal. For example, an aluminum shell is manufactured using an aluminum alloy material, different from a well-known aluminum-plastic film in the art. Selection of a steel shell or an aluminum shell as the housing in this application can further reduce a swelling rate of the secondary battery and increase the energy density of the secondary battery on the basis of improving the safety performance of the secondary battery.

In some embodiments of this application, as shown in FIG. 1 and FIG. 2, the adhesion layer 10 is provided on the bottom surface 21 of the recess, and also on a surface of an inner side wall 22 of the recess. Provision of the adhesion layer on both the bottom surface of the recess and the surface of the inner side wall of the recess and adhesion of the electrode assembly to both the bottom surface and inner side wall of the lower housing body are more conducive to providing buffering, so that when the secondary battery is subjected to drop, collision, or the like, the probability that a head, connected to a tab, of the electrode assembly impacts on the housing due to inertia is further reduced, reducing the possibility of contact between the electrode assembly and the housing during dropping, thus reducing the risk of short-circuit of the secondary battery, and the adhesion area between the adhesion layer and the electrode assembly is larger, so as to further reduce the risk of tab connection failure caused by movement of the electrode assembly inside the housing. As a result, the safety performance of the secondary battery are further improved. In addition, the provision of the adhesion layer realizes adhesion and insulation effects, featuring the effects of both hot-melt adhesive with adhesion function and winding adhesive in the prior art, and the application process of the adhesion layer is also simpler compared with the adhesive application process. Therefore, the energy density of the secondary battery is also increased, and the production costs of the secondary battery are reduced.

In some embodiments of this application, as shown in FIG. 1 and FIG. 3, the upper housing body 30 is plate-shaped, the adhesion layer 10 is provided on an inner surface of the upper housing body 30, and also on the bottom surface 21 of the recess of the lower housing body 20. Provision of the adhesion layer on both the bottom surface of the recess and the inner surface of the upper housing body and adhesion of two surfaces of the electrode assembly in its thickness direction both to the housing are more conducive to providing buffering, so that when the secondary battery is subjected to drop, collision, or the like, the probability that a head, connected to a tab, of the electrode assembly impacts on the housing due to inertia is further reduced, reducing the possibility of contact between the electrode assembly and the housing during dropping, thus reducing the risk of short-circuit of the secondary battery, and the adhesion area between the adhesion layer and the electrode assembly is larger, so as to further reduce the risk of tab connection failure caused by movement of the electrode assembly inside the housing. As a result, the safety performance of the secondary battery are further improved. In addition, the provision of the adhesion layer realizes adhesion and insulation effects, featuring the effects of both hot-melt adhesive with adhesion function and winding adhesive in the prior art, and the application process of the adhesion layer is also simpler compared with the adhesive application process. Therefore, the energy density of the secondary battery is also increased, and the production costs of the secondary battery are reduced.

In some embodiments of this application, as shown in FIG. 1 to FIG. 3, the upper housing body 30 is plate-shaped, the adhesion layer 10 is provided on the inner surface 23 of the upper housing body 30, also on the bottom surface 21 of the recess of the lower housing body 20, and still also on the surface of the inner side wall 22 of the recess of the lower housing body 20. Provision of the adhesion layer on each of the bottom surface of the recess, the inner side wall of the recess, and the inner surface of the upper housing body and adhesion of each outer surface of the electrode assembly to the housing are more conducive to providing buffering, so that when the secondary battery is subjected to drop, collision, or the like, the probability that a head, connected to a tab, of the electrode assembly impacts on the housing due to inertia is further reduced, reducing the possibility of contact between the electrode assembly and the housing during dropping, thus reducing the risk of short-circuit of the secondary battery, and the adhesion area between the adhesion layer and the electrode assembly is larger, so as to further reduce the risk of tab connection failure caused by movement of the electrode assembly inside the housing. As a result, the safety performance of the secondary battery are further improved. In addition, the provision of the adhesion layer realizes adhesion and insulation effects, featuring the effects of both hot-melt adhesive with adhesion function and winding adhesive in the prior art, and the application process of the adhesion layer is also simpler compared with the adhesive application process. Therefore, the energy density of the secondary battery is also increased, and the production costs of the secondary battery are reduced.

In some embodiments of this application, when viewed from a thickness direction of the secondary battery, a distance L from an edge of the adhesion layer to a corresponding outer side edge of the upper housing body or the lower housing body is 6 mm to 10 mm. For example, the distance L is 6 mm, 7 mm, 8 mm, 9 mm, 10 mm, or any value within a range defined by any two of these values. It can be understood that the above “outer side edge of the upper housing body or the lower housing body” includes each edge where the bottom surface and inner side wall of the recess are connected, and each edge where the upper housing body and the lower housing body are connected, and that the “distance L from an edge of the adhesion layer to a corresponding outer side edge of the upper housing body or the lower housing body” refers to a distance from any position on the edge of the adhesion layer to each of the above connected edges with a closest perpendicular distance thereto. For example, as shown in FIG. 1, when the adhesion layer 10 is provided on the bottom surface 21 of the recess, the distance from an edge of the adhesion layer 10 to a corresponding outer side edge of the lower housing body 20 is L₁ in FIG. 1; as shown in FIG. 2, when the adhesion layer 10 is provided on the surface of the inner side wall 22 of the recess, the distance from an edge, closer to the bottom surface 21, of the adhesion layer 10 to a corresponding outer side edge of the lower housing body 20 is L₂₋₁ in FIG. 2, and the distance from an edge, farther away from the bottom surface 21, of the adhesion layer 10 to a corresponding outer side edge of the lower housing body 20 is L₂₋₂ in FIG. 2; and as shown in FIG. 3, when the adhesion layer 10 is provided on the inner surface 23 of the upper housing body 30, the distance from an edge of the adhesion layer 10 to a corresponding outer side edge of the upper housing body 30 is L₃ in FIG. 3. When the adhesion layer is provided on the bottom surface of the recess, the inner surface of the recess, and the inner surface of the upper housing body, the distance L from an edge of the adhesion layer to a corresponding outer side edge of the upper housing body or lower housing body being controlled within the foregoing range allows for an area without adhesive to be left between the outer side edge of the upper housing body or the lower housing body and the adhesion layer. In this way, during packaging of the secondary battery, a risk of a flange welding region coming into contact with the adhesion layer and affecting the welding is reduced, and a possibility of packaging failure is reduced. As a result, the packaging performance and safety performance of the secondary battery are improved.

In some embodiments of this application, the adhesion layer includes an aqueous binder; and the aqueous binder includes a copolymer of a first monomer and a second monomer, where the first monomer includes at least one of ethyl methacrylate, butyl acrylate, or 2-ethylhexyl acrylate, and the second monomer includes at least one of styrene, acrylonitrile, or vinyl acetate. The aqueous binder produced by copolymerization of the first monomer and second monomer of the above types is selected, which exhibits good resistance to electrolyte and is less likely to decompose when soaked in electrolyte. The above aqueous binder is prepared into an adhesion layer, and the adhesion layer adheres the electrode assembly to the housing, so during subsequent use of the secondary battery, a possibility that adhesion force of the adhesion layer is reduced due to soaking in electrolyte is reduced. As a result, the safety performance of the secondary battery is improved. In addition, the aqueous binder is environmentally friendly and pollution-free, more conducive to protection of the environment.

In some embodiments of this application, a mass ratio of the first monomer to the second monomer is 1:1.0 to 1:1.5. For example, the mass ratio of the first monomer to the second monomer is 1:1.0, 1:1.1, 1:1.2, 1:1.3, 1:1.4, 1:1.5, or any value within a range defined by any two of these values. The mass ratio of the first monomer to the second monomer is controlled within the above range such that the electrolyte resistance of the prepared aqueous binder can be further improved, thus more conducive to improving the safety performance of the secondary battery.

In some embodiments of this application, the adhesion layer further includes an additive, and the additive includes at least one of a plasticizer, a thickener, or a dispersant. The adhesive prepared by using the additive of the above types in combination with the aqueous binder, when applied on a surface of the housing, is more conducive to formation of an adhesion layer of uniform thickness and composition, thereby more conducive to the adhesion layer adhering the electrode assembly to the housing. Therefore, the safety performance of the secondary battery is improved.

In some embodiments of this application, the adhesion layer includes an oily binder, and the oily binder includes at least one of polyacrylic acid, polyvinylidene fluoride, polymethyl acrylate, polyethylene acrylate, poly-2-methyl methacrylate, poly-2-ethyl methacrylate, styrene acrylate copolymer, polyacrylonitrile, polyacrylamide, polyimide, or polyamide. Selection of the adhesion layer prepared by using the oily binder of the above types is more conducive to adhering the electrode assembly to the housing, and the oily binder also has good electrolyte resistance and is less likely to decompose in electrolyte. In this way, during subsequent use of the secondary battery, the possibility that adhesion force of the adhesion layer is reduced due to soaking in electrolyte is reduced. Therefore, the safety performance of the secondary battery is improved.

In some embodiments of this application, thickness of the adhesion layer is 5 μm to 20 μm. For example, the thickness of the adhesion layer is 5 μm, 8 μm, 11 μm, 14 μm, 17 μm, 20 μm, or any value within a range defined by any two of these values. In the prior, thickness of the hot-melt adhesive paper for adhering the electrode assembly to the housing is typically 25 μm to 50 μm, and thickness of the winding adhesive with an insulation function tends is typically about 20 μm. In this application, the thickness of the adhesion layer being controlled within the above range can reduce the risk of loss of energy density caused by an increase in size of the secondary battery due to provision of the hot-melt adhesive paper and winding adhesive paper, thereby increasing the energy density of the secondary battery on the basis of improving the safety performance of the secondary battery.

In some embodiments of this application, adhesion force of the adhesion layer after soaking in a test electrolyte is 50 N/m to 200 N/m. For example, the adhesion force of the adhesion layer after soaking in a test electrolyte is 50 N/m, 80 N/m, 110 N/m, 140 N/m, 170 N/m, 200 N/m, or any value within a range defined by any two of these values. This indicates that the adhesion layer has good electrolyte resistance and still exhibits desirable adhesion force even after soaking in the test electrolyte. Thus, the adhesion layer is still capable of adhering the electrode assembly to the housing during subsequent use of the secondary battery. In addition, a risk that an outermost current collector (for example, an aluminum foil) of the electrode assembly is subjected to tearing due to excessive adhesion force is low. Therefore, the safety performance of the secondary battery is improved.

A structure of the electrode assembly is not particularly limited in this application, provided that the objectives of this application can be achieved. For example, the electrode assembly is of a wound structure or a stacked structure. Preferably, the electrode assembly is of a stacked structure, and as compared with a wound structure, the electrode assembly of the stacked structure, by its own structure, is more conducive to improving the safety performance of the secondary battery. The electrode assembly in this application includes a positive electrode plate, a separator, and a negative electrode plate, where the separator is located between the positive electrode plate and the negative electrode plate for separating the positive electrode plate and the negative electrode plate to prevent an internal short-circuit in the secondary battery, and the separator allows for free passage of electrolyte ions for completing an electrochemical charge and discharge process. In this application, quantities of the separator, positive electrode plate, and negative electrode plate in the electrode assembly is not particularly limited, provided that the objectives of this application can be achieved. Types of the positive electrode plate, separator, and negative electrode plate are not particularly limited in this application and can be selected by persons skilled in the art depending on actual requirements, provided that the objectives of this application can be achieved.

For example, in some embodiments of this application, the positive electrode plate includes a positive electrode active material layer and a positive electrode current collector, the positive electrode active material layer is provided on one surface or two surfaces of the positive electrode current collector in a thickness direction of the positive electrode current collector, and the positive electrode active material layer includes a positive electrode active material. The negative electrode plate includes a negative electrode active material layer and a negative electrode current collector, the negative electrode active material layer is provided on one surface or two surfaces of the negative electrode current collector in a thickness direction of the negative electrode current collector, and the negative electrode active material layer includes a negative electrode active material. The positive electrode active material, the positive electrode current collector, the negative electrode active material, and the negative electrode current collector are not particularly limited in this application and can be selected by persons skilled in the art depending on actual requirements, provided that the objectives of this application can be achieved.

The secondary battery in this application further includes an electrolyte, where the electrolyte is not particularly limited in this application and can be selected by persons skilled in the art depending on actual requirements, provided that the objectives of this application can be achieved.

The secondary battery in this application is not particularly limited and may include any apparatus in which an electrochemical reaction occurs. For example, the secondary battery may include but is not limited to a lithium metal secondary battery, a lithium-ion secondary battery (lithium-ion battery), a sodium-ion secondary battery, a lithium polymer secondary battery, and a lithium-ion polymer secondary battery.

A shape of the secondary battery is not particularly limited in this application, provided that the objectives of this application can be achieved. For example, when the secondary battery is a lithium-ion battery, the secondary battery may include but is not limited to the following shaped batteries: an L-shaped lithium-ion battery, an arc-shaped lithium-ion battery, a step-shaped lithium-ion battery, an arc-and-step-shaped lithium-ion battery, and a button battery.

A preparation method of secondary battery is not particularly limited in this application, and a well-known preparation method in the art can be used, provided that the objectives of this application can be achieved. For example, the preparation method of secondary battery includes but is not limited to the following steps: stacking a positive electrode plate, a separator, and a negative electrode plate in sequence, performing operations such as winding and folding on the stack as required to obtain an electrode assembly having a winding structure, placing the electrode assembly into a housing provided with an adhesive film (which can also be understood as an adhesion layer that has not undergone a hot-press activation treatment), injecting an electrolyte into the housing, and sealing the housing to obtain a secondary battery; or stacking a positive electrode plate, a separator, and a negative electrode plate in sequence, activating adhesion force of the separator through hot pressing to adhere the positive electrode plate, the negative electrode plate, and the separator to each other so that the electrode assembly does not fall apart, placing the electrode assembly into a housing provided with an adhesive film (which can also be understood as an adhesion layer that has not undergone a hot-press activation treatment), injecting an electrolyte into the housing, and sealing the housing to obtain a secondary battery.

A preparation method of the foregoing adhesion layer is not particularly limited in this application, provided that the objectives of this application can be achieved. For example, the preparation method of the adhesion layer includes but is not limited to the following steps: applying an adhesive for preparing adhesion layer onto at least one of the bottom surface of the recess, the surface of the inner side wall of the recess, or the inner surface of the upper housing body in a manner such as spraying or brushing, and after application of the adhesive is completed, drying the housing in an oven at 50° C. to 70° C. for 25 s to 35 s, or performing natural air-drying for 3 min to 5 min for solvent evaporation of the adhesive, so that an adhesive film is formed after curing of the adhesive. During subsequent packaging of the secondary battery, the adhesive film is hot pressed at a temperature of 70° C. to 85° C. and under a pressure of 1.0 MPa to 1.2 MPa for 10 min to 60 min to be activated for the formation of the adhesion layer with adhesion force, so that the electrode assembly is adhered to the housing to form an entirety. Subsequently, the adhesion layer formed by the aqueous binder is placed under high temperature and pressure of the formation process of the secondary battery, so that adhesion force of a part, that has not been activated in the previous process, of the adhesive film of the adhesion layer is further activated, thus further increasing the adhesion force of the adhesion layer. The adhesion layer formed by the oily binder has surface viscosity and an adhesion force accounting for 35% to 45% of the overall adhesion force of the adhesion layer without hot pressing activation, and the adhesion force of the adhesion layer is further improved after soaking in electrolyte.

In this application, unless otherwise specified, the adhesion layer generally refers to an adhesion layer that has been activated through hot pressing and has adhesion force.

A preparation method of adhesive for preparing adhesion layer is not particularly limited in this application, provided that the objectives of this application can be achieved. For example, the adhesive can be prepared in the following steps: mixing the aqueous binder, plasticizer, thickener, and dispersant in this application at a mass ratio of (70-80):(10-20):(10-20):(0-10), and then adding them to a first organic solvent and stirring well to obtain the adhesive. Alternatively, the oily binder in this application is mixed with a second organic solvent and stirred well to obtain the adhesive. To make the thickness of the adhesion layer uniform and control the thickness of the adhesion layer within the range given in this application, a solid content of the adhesive is 10 wt % to 40 wt %.

Types of the plasticizer, thickener, dispersant, first organic solvent, and second organic solvent are not particularly limited in this application, provided that the objectives of this application can be achieved. For example, the plasticizer includes at least one of dimethyl phthalate, diethyl phthalate, dipropyl phthalate, methyl benzoate, ethyl benzoate, or propyl benzoate. The thickener includes at least one of 2-methyl methacrylate, polymethyl acrylate, polyethylene acrylate, polypropyl acrylate, or the like. The dispersant includes at least one of sodium silicate, sodium tripolyphosphate, sodium hexametaphosphate, sodium pyrophosphate, or the like. The first organic solvent includes at least one of trichloromethane, toluene, xylene, methyl ethyl ketone, cyclohexanone, n-butanol, or the like. The second organic solvent includes at least one of toluene, xylene, methyl ethyl ketone, cyclohexanone, n-butanol, or the like.

A second aspect of this application provides an electronic apparatus including the secondary battery according to the first aspect of this application. Therefore, the electronic apparatus has good safety performance.

The electrochemical apparatus in this application is not particularly limited, and may be any known electronic apparatus used in the prior art. For example, the electronic apparatus may include but is not limited to notebook computer, a pen-input computer, a mobile computer, an electronic book player, a portable telephone, a portable fax machine, a portable copier, a portable printer, a headset, a video recorder, a liquid crystal display television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, or a lithium-ion capacitor.

### EXAMPLES

The following describes some embodiments of this application more specifically by using examples and comparative examples. Various tests and evaluations are performed in the following methods.

### Test Method and Device

### Adhesion Force Test

(1) The lithium-ion battery in each example and comparative example was taken and discharged to state of charge (SOC)=0%.

(2) The lithium-ion battery was disassembled and unnecessary part of the housing was removed by cutting along a periphery of the lithium-ion battery.

(3) The lithium-ion battery obtained in step (2) was placed in a test electrolyte and soaked there for 4 h in an oven at 85° C., and then the battery was taken out and air-dried at room temperature.

(4) Adhesion force test was performed on the electrode assembly and adhesion layer using a tensile machine.

(5) The housing was fixed on one side of the tensile machine and the electrode assembly on another side.

(6) The original F-X (tension-displacement) data of the tensile machine was recorded and analyzed, and finally the average value of the tension in a stable region was measured and denoted as the adhesion force.

The test electrolyte was prepared as follows: in a dry argon atmosphere, ethylene carbonate (EC), ethyl methyl carbonate (EMC), and diethyl carbonate (DEC) were mixed at a mass ratio of 30:50:20 to obtain an organic solvent, and then a lithium salt lithium hexafluorophosphate was added to the organic solvent and dissolved and well mixed, to obtain the test electrolyte with a lithium salt concentration of 1.15 mol/L.

### Test for Drop Pass Rate

### (1) Test for 1.0 Meter Drop Pass Rate of Lithium-Ion Battery

(1) The voltage was 4.45 V and SOC=100% for the lithium-ion battery before dropping in each example and comparative example.

(2) Test temperature was 20±5° C.

(3) The voltage of the lithium-ion battery was adjusted to 4.45 V and the internal resistance to 19 mΩ, and the battery was placed in a drop clamp.

(4) The appearance of the lithium-ion battery was checked and photographed.

(5) In a test environment at 20±5° C. with a marble drop floor, from 1.0 meter drop height, the battery was dropped for 1 time for each of its 6 surfaces with the surface facing downward, and for 1 time for each of its 4 corners with the corner facing downward, and the test included a total of 5 rounds with a drop sequence (the battery was freely dropped from a position with a height of 1.0 meter to the smooth marble surface; and the drop sequence for the battery was as follows: first, the bottom surface, followed by the top, left, right, front, and back surfaces, and the upper-left, upper-right, lower-right, and lower-left corners (the pit surface being the front surface)).

(6) Measurement frequency: The 1 KHz standard was used for voltage and internal resistance measurements, the measurement was performed after pretreatment, after test, during test, and at the 24th, 48th, and 72nd hours after test. The first phase of the test included 5 rounds, and the measurement was performed for each round.

(7) Appearance of the lithium-ion battery after completion of dropping was checked, and whether the lithium-ion battery experienced failure was determined according to the following requirements. No failure indicated a pass of the lithium-ion battery.

Determination criteria for no failure of lithium-ion battery: no smoke, no fire, and no burning on the housing.

10 lithium-ion batteries were tested for each example or comparative example, and the 1.0 meter drop pass rate (%)=the number of lithium-ion batteries that passed the test/10×100%.

### (2) Test for 1.5 Meter Drop Pass Rate of Lithium-Ion Battery

This test was the same as the above (1) Test for 1.0 meter drop pass rate of lithium-ion battery except that the 1.0 meter drop in (5) was adjusted to 1.5 meter drop.

### Test for Collision Pass Rate

In a test environment at 20±5° C., the lithium-ion battery under test as a sample was placed on a test bench, and a round bar with a diameter φ of 15.8±0.1 mm and a length of at least 6 cm was placed in the center of a wider surface of the sample. The longitudinal axis of the sample was parallel to a surface of the test bench and perpendicular to the longitudinal axis of the round bar. A hammer of 9.1±0.1 kg was used to be vertically dropped in a free state from a height of 610±25 mm, landing at the intersection of the round bar and the sample.

Determination criteria: no fire or explosion indicated a pass of the lithium-ion battery.

10 lithium-ion batteries were tested for each example or comparative example, and the collision pass rate (%)=the number of lithium-ion batteries that passed the test/10×100%.

### Example 1-1

### <Preparation of Electrolyte>

In a dry argon atmosphere, dioxolane and dimethyl ether were mixed at a mass ratio of 1:1 to obtain an organic solvent, and then a lithium salt lithium bistrifluoromethanesulfonimide was added to the organic solvent and dissolved and well mixed, to obtain an electrolyte with a lithium salt concentration of 1.0 mol/L.

### <Preparation of Negative Electrode Plate>

A negative electrode active material graphite, a negative electrode conductive agent graphite, a negative electrode conductive agent carbon black, and a negative electrode binder carboxymethylcellulose sodium were mixed at a mass ratio of 95:1:2:2, and the resulting mixture was dispersed uniformly in distilled water and well stirred by a vacuum stirrer to obtain a negative electrode slurry with a solid content of 75 wt %. The negative electrode slurry was uniformly applied on one surface of a negative electrode current collector copper foil with a thickness of 12 μm, and the copper foil was dried at 85° C. to obtain a negative electrode plate with a coating thickness of 75 μm and with one surface coated with a negative electrode active material layer. The foregoing steps were repeated on the other surface of the copper foil to obtain a double-sided negative electrode plate coated with the negative electrode active material layer on two surfaces. After drying, cold pressing, cutting, and slitting, a 41 mm×61 mm negative electrode plate was obtained.

### <Preparation of Positive Electrode Plate>

A positive electrode active material lithium iron phosphate, a positive electrode conductive agent conductive carbon black, and a positive electrode binder polyvinylidene fluoride were mixed at a mass ratio of 97.5:1.0:1.5, added with N-methylpyrrolidone, and well stirred by a vacuum stirrer to obtain a positive electrode slurry with a solid content of 75 wt %. The positive electrode slurry was uniformly applied on one surface of a positive electrode current collector aluminum foil with a thickness of 10 μm, and the aluminum foil was dried at 90° C. to obtain a positive electrode plate with one surface coated with a positive electrode active material layer. The foregoing steps were repeated on the other surface of the aluminum foil to obtain a positive electrode plate coated with the positive electrode active material layer on two surfaces. After drying, cold pressing, cutting, and slitting, a 38 mm×58 mm positive electrode plate was obtained.

### <Preparation of Separator>

A polyethylene film (provided by Celgard) with a thickness of 11 μm was used.

### <Preparation of Lithium-Ion Battery>

The separator was sandwiched between the foregoing prepared positive electrode plate and negative electrode plate, and after stacking, four corners of the stacked structure were fixed to form an electrode assembly of a stacked structure, where the number of layers of the positive electrode plate was 17, the number of layers of the negative electrode plate was 18, and the number of layers of the separator was 34. The negative electrode plate included 2 layers of single-sided negative electrode plate and 16 layers of two-sided positive electrode plate, where the 2 layers of single-sided negative electrode plate were the outermost layers of the electrode assembly respectively.

An aqueous binder produced by copolymerization of a first monomer ethyl methacrylate and a second monomer styrene at a mass ratio of 1:1, a plasticizer ethyl benzoate, a thickener 2-methyl methacrylate, and a dispersant sodium tripolyphosphate were mixed at a mass ratio of 9:3:2:1, and then added to a first organic solvent trichloromethane and well stirred, to obtain an adhesive with a solid content of 10 wt %.

The foregoing prepared adhesive was applied on a housing through spraying, specifically, on a bottom surface of a recess, a surface of an inner side wall of the recess, and an inner surface of an upper housing body, and after completion of the coating, the housing was dried in an oven at 60° C. for 30 s so that an adhesive film was formed after curing of the adhesive.

The foregoing prepared electrode assembly was placed into the housing provided with the adhesive film, the upper housing body and a lower housing body were flange-welded to seal and enclose the electrode assembly, and the lithium-ion battery after welding was hot-pressed for 10 min at 85° C. and under 1.1 MPa. Then, the electrolyte was injected, followed by formation, and an adhesion layer adhered the electrode assembly to the housing to obtain a final lithium-ion battery.

A distance L from an edge of the adhesion layer to a corresponding outer side edge of the upper housing body or the lower housing body was 6 mm; and thickness of the adhesion layer was 5 μm.

### Example 1-2

This example was the same as example 1-1 except that in <Preparation of lithium-ion battery>, the adhesive was not applied on the surface of the inner side wall of the recess or the inner surface of the upper housing body, and the adhesion layer was not provided on the surface of the inner side wall of the recess or the inner surface of the upper housing body, but only on the bottom surface of the recess.

### Example 1-3

This example was the same as example 1-1 except that in <Preparation of lithium-ion battery>, the adhesive was not applied on the inner surface of the upper housing body, and the adhesion layer was not provided on the inner surface of the upper housing body, but only on the bottom surface of the recess and the surface of the inner side wall of the recess.

### Examples 1-4 to 1-7

These examples were the same as example 1-1 except that the related preparation parameters were adjusted according to Table 1.

### Examples 2-1 to 2-10

These examples were the same as example 1-1 except that the related preparation parameters were adjusted according to Table 2.

### Example 2-11

This example was the same as example 1-1 except that in <Preparation of lithium-ion battery>, an oily binder polyacrylic acid (with a viscosity-average molecular weight My of 3,000,000) and a second organic solvent toluene were mixed to obtain an adhesive with a solid content of 10 wt %.

### Example 2-12

This example was the same as example 2-11 except that the related preparation parameters were adjusted according to Table 2.

### Comparative Example 1

This example was the same as example 1-1 except that in <Preparation of lithium-ion battery>, no adhesion layer was provided, a winding adhesive (manufacturer: 3M, dimension: thickness×width=10 μm×10 mm) was applied around the outer surface of the electrode assembly, and styrene-isoprene-styrene (SIS) adhesive paper was applied between the electrode assembly and the lower housing body to adhere the electrode assembly to the housing.

Thickness of the SIS adhesive paper was 25 μm.

The preparation parameters and performance parameters of examples and comparative examples are shown in Table 1 and Table 2.

TABLE 1

| | | | | Drop pass rate | Drop pass rate | |
|---|---|---|---|---|---|---|
| | | | | for 5 rounds of | for 5 rounds of | |
| | | | Adhesion | 1.0-meter-6- | 1.5-meter-6- | |
| | Position of | L | force | surface-and-4- | surface-and-4- | Collision |
| | adhesion layer | (mm) | (N/m) | corner drop | corner drop | pass rate |
| Example | Bottom surface of | 6 | 200 | 100% | 100% | 80% |
| 1-1 | recess, surface of | | | | | |
| | inner side wall of | | | | | |
| | recess, and inner | | | | | |
| | surface of upper | | | | | |
| | housing body | | | | | |
| Example | Bottom surface of | 6 | 200 | 100% | 70% | 40% |
| 1-2 | recess | | | | | |
| Example | Bottom surface of | 6 | 200 | 100% | 90% | 50% |
| 1-3 | recess and surface | | | | | |
| | of inner side wall | | | | | |
| | of recess | | | | | |
| Example | Bottom surface of | 8 | 200 | 100% | 100% | 80% |
| 1-4 | recess, surface of | | | | | |
| | inner side wall of | | | | | |
| | recess, and inner | | | | | |
| | surface of upper | | | | | |
| | housing body | | | | | |
| Example | Bottom surface of | 10 | 200 | 100% | 100% | 80% |
| 1-5 | recess, surface of | | | | | |
| | inner side wall of | | | | | |
| | recess, and inner | | | | | |
| | surface of upper | | | | | |
| | housing body | | | | | |
| Example | Bottom surface of | 5 | 200 | 96% | 60% | 40% |
| 1-6 | recess, surface of | | | | | |
| | inner side wall of | | | | | |
| | recess, and inner | | | | | |
| | surface of upper | | | | | |
| | housing body | | | | | |
| Example | Bottom surface of | 12 | 200 | 95% | 70% | 50% |
| 1-7 | recess, surface of | | | | | |
| | inner side wall of | | | | | |
| | recess, and inner | | | | | |
| | surface of upper | | | | | |
| | housing body | | | | | |
| Comparative | \ | \ | 200 (adhesion | 80% | 50% | 30% |
| example 1 | | | force of SIS | | | |
| | | | adhesive tape) | | | |

Note:
“\” in Table 1 indicates that there is no corresponding parameter.

It can be seen from examples 1-1 to 1-3 and comparative examples 1 and 2 that the safety performance of the lithium-ion battery changes with the provision of the adhesion layer. In examples 1-1 to 1-3, the adhesion layer in this application is provided on the bottom surface of the recess and on at least one of the surface of the inner side wall of the recess or the inner surface of the upper housing body, and the adhesion layer adheres the electrode assembly to the housing, making the electrode assembly and the housing form an entirety, so that the obtained lithium-ion battery has higher adhesion force, drop pass rate for 5 rounds of 1.0-meter-6-surface-and-4-corner drop (hereinafter referred to as 1.0 meter drop pass rate), drop pass rate for 5 rounds of 1.5-meter-6-surface-and-4-corner drop (hereinafter referred to as 1.5 meter drop pass rate), and collision pass rate, indicating that the lithium-ion battery has good safety performance. Whereas in comparative example 1, although the adhesive paper is provided to adhere the electrode assembly to the housing, the adhesion force, the 1.0 meter drop pass rate, the 1.5 meter drop pass rate, and the collision pass rate are lower than those in examples 1-1 to 1-5, indicating that the adhesive effect of the adhesive paper on the electrode assembly and the housing is worse than that of the adhesion layer in this application on the electrode assembly and the housing, and that the lithium-ion battery in this application has better safety performance. Moreover, in comparative example 1, the winding adhesive is applied around the outer surface of the electrode assembly, the thickness of winding adhesive paper being 10 μm, such that the winding adhesive increases the thickness of the electrode assembly by 20 μm, and the thickness of the SIS adhesive paper is 25 μm, so the volume of the lithium-ion battery is increased and the energy density of the battery is reduced; whereas the thickness of the adhesion layer in this application is 5 μm, and the risk of reduction of energy density of the lithium-ion battery caused by increase in the volume of the lithium-ion battery is reduced as compared with comparative example 1, so that the energy density of the lithium-ion battery in this application is improved.

The distance L from an edge of the adhesion layer to a corresponding outer side edge of the upper housing body or the lower housing body generally also affects the safety performance of the lithium-ion battery. It can be seen from example 1-1 and examples 1-4 to 1-7 that the lithium-ion battery in which the distance L from an edge of the adhesion layer to a corresponding outer side edge of the upper housing body or the lower housing body within the range given in this application is selected exhibits higher adhesion force, 1.0 meter drop pass rate, 1.5 meter drop pass rate, and collision pass rate, thus indicating that the battery has good safety performance.

TABLE 2

| | Solid | | | | | Thickness | | | | |
|---|---|---|---|---|---|---|---|---|---|---|
| | content of | | | | | of adhesion | Adhesion | 1.0 | 1.5 | |
| | adhesive | First | Second | | Oily | layer | force | meter drop | meter drop | Collision |
| | (wt %) | monomer | monomer | N | binder | (μm) | (N/m) | pass rate | pass rate | pass rate |
| Example | 10 | Ethyl | Styrene | 1:1 | \ | 5 | 200 | 100% | 100% | 80% |
| 1-1 | | methacrylate | | | | | | | | |
| Example | 15 | Ethyl | Styrene | 1:1 | \ | 10 | 200 | 100% | 100% | 80% |
| 2-1 | | methacrylate | | | | | | | | |
| Example | 40 | Ethyl | Styrene | 1:1 | \ | 20 | 220 | 100% | 100% | 80% |
| 2-2 | | methacrylate | | | | | | | | |
| Example | 8 | Ethyl | Styrene | 1:1 | \ | 3 | 80 | 100% | 70% | 60% |
| 2-3 | | methacrylate | | | | | | | | |
| Example | 45 | Ethyl | Styrene | 1:1 | \ | 25 | 200 | 100% | 80% | 65% |
| 2-4 | | methacrylate | | | | | | | | |
| Example | 15 | Butyl | Styrene | 1:1 | \ | 10 | 120 | 100% | 90% | 80% |
| 2-5 | | acrylate | | | | | | | | |
| Example | 15 | Ethyl | Vinyl | 1:1 | \ | 10 | 130 | 100% | 90% | 80% |
| 2-6 | | methacrylate | acetate | | | | | | | |
| Example | 15 | Ethyl | Styrene | 1:1.2 | \ | 10 | 140 | 100% | 90% | 84% |
| 2-7 | | methacrylate | | | | | | | | |
| Example | 15 | Ethyl | Styrene | 1:1.5 | \ | 10 | 150 | 100% | 90% | 84% |
| 2-8 | | methacrylate | | | | | | | | |
| Example | 15 | Ethyl | Styrene | 1:0.8 | \ | 10 | 100 | 100% | 80% | 70% |
| 2-9 | | methacrylate | | | | | | | | |
| Example | 15 | Ethyl | Styrene | 1:1.7 | \ | 10 | 100 | 100% | 70% | 60% |
| 2-10 | | methacrylate | | | | | | | | |
| Example | | \ | \ | \ | Polyacrylic acid | 10 | 120 | 100% | 100% | 80% |
| 2-11 | | | | | | | | | | |
| Example | | \ | \ | \ | Polyvinylidene | 10 | 120 | 100% | 100% | 80% |
| 2-12 | | | | | fluoride (with | | | | | |
| | | | | | a weight-average | | | | | |
| | | | | | molecular weight | | | | | |
| | | | | | of 65,000) | | | | | |

Note:
in Table 2, “N” indicates the mass ratio of the first monomer to the second monomer, and “\” indicates that there is no corresponding parameter.

The thickness of the adhesion layer generally also affects the safety performance of the lithium-ion battery. It can be seen from example 1-1 and examples 2-1 to 2-4 that the lithium-ion battery in which the thickness of the adhesion layer within the range given in this application is selected exhibits higher adhesion force, 1.0 meter drop pass rate, 1.5 meter drop pass rate, and collision pass rate, thus indicating that the battery has good safety performance.

The types of the first monomer and second monomer generally also affect the safety performance of the lithium-ion battery. It can be seen from example 2-1 and examples 2-5 and 2-6 that the lithium-ion battery in which the types of the first monomer and second monomer within the ranges given in this application are selected exhibits higher adhesion force, 1.0 meter drop pass rate, 1.5 meter drop pass rate, and collision pass rate, thus indicating that the battery has good safety performance.

The mass ratio N of the first monomer to the second monomer generally also affects the safety performance of the lithium-ion battery. It can be seen from example 2-1 and examples 2-7 and 2-10 that the lithium-ion battery in which the mass ratio N of the first monomer to the second monomer within the range given in this application is selected exhibits higher adhesion force, 1.0 meter drop pass rate, 1.5 meter drop pass rate, and collision pass rate, thus indicating that the battery has good safety performance.

The type of the oily binder generally also affects the safety performance of the lithium-ion battery. It can be seen from examples 2-1 to 2-12 that the lithium-ion battery in which the type of the oily binder within the range given in this application is selected exhibits higher adhesion force, 1.0 meter drop pass rate, 1.5 meter drop pass rate, and collision pass rate, thus indicating that the battery has good safety performance.

It should be noted that relational terms such as “first” and “second” are only used to distinguish one entity or operation from another entity or operation, and do not necessarily require or imply that there is any such actual relationship or order between these entities or operations. In addition, the terms “include”, “comprise”, or any of their variants are intended to cover a non-exclusive inclusion, such that a process, method, or article that includes a series of elements includes not only those elements but also other elements that are not expressly listed, or further includes elements inherent to such process, method, or article.

Some embodiments in this specification are described in a related manner. For a part that is the same or similar between different embodiments, reference may be made between the embodiments. Each embodiment focuses on differences from other embodiments.

The foregoing descriptions are merely preferred examples of this application, and are not intended to limit the protection scope of this application. Any modifications, equivalent replacements, and improvements made without departing from the spirit and principle of this application shall fall within the protection scope of this application.

What is claimed is:

1. A secondary battery, comprising an electrode assembly, a housing, and an adhesion layer; wherein the housing comprises an upper housing body and a lower housing body, the lower housing body is provided with a recess for accommodating the electrode assembly, the upper housing body is configured to cover the recess, the adhesion layer is provided on a bottom surface of the recess opposite to the upper housing body, the housing is a metal housing, and the adhesion layer adheres the electrode assembly to the housing.

2. The secondary battery according to claim 1, wherein the adhesion layer is further provided on a surface of an inner side wall of the recess.

3. The secondary battery according to claim 1, wherein the upper housing body is plate-shaped, and the adhesion layer is further provided on an inner surface of the upper housing body.

4. The secondary battery according to claim 3, wherein when viewed from a thickness direction of the secondary battery, a distance from an edge of the adhesion layer to a corresponding outer side edge of the upper housing body or the lower housing body is 6 mm to 10 mm.

5. The secondary battery according to claim 1, wherein the adhesion layer comprises an aqueous binder; and
the aqueous binder comprises a copolymer of a first monomer and a second monomer, wherein the first monomer comprises at least one of ethyl methacrylate, butyl acrylate, or 2-ethylhexyl acrylate; and the second monomer comprises at least one of styrene, acrylonitrile, or vinyl acetate.

6. The secondary battery according to claim 5, wherein a mass ratio of the first monomer to the second monomer is 1:1.0 to 1:1.5.

7. The secondary battery according to claim 5, wherein the adhesion layer further comprises an additive; and the additive comprises at least one of a plasticizer, a thickener, or a dispersant.

8. The secondary battery according to claim 1, wherein the adhesion layer comprises an oily binder; and the oily binder comprises at least one of polyacrylic acid, polyvinylidene fluoride, polymethyl acrylate, polyethylene acrylate, poly-2-methyl methacrylate, poly-2-ethyl methacrylate, styrene acrylate copolymer, polyacrylonitrile, polyacrylamide, polyimide, or polyamide.

9. The secondary battery according to claim 1, wherein a thickness of the adhesion layer is 5 μm to 20 μm.

10. The secondary battery according to claim 1, wherein an adhesion force of the adhesion layer after soaking in a test electrolyte is 50 N/m to 200 N/m.

11. An electronic apparatus, comprising a secondary battery, the secondary battery comprising an electrode assembly, a housing and an adhesion layer; wherein the housing comprises an upper housing body and a lower housing body, the lower housing body is provided with a recess for accommodating the electrode assembly, the upper housing body is configured to cover the recess, the adhesion layer is provided on a bottom surface of the recess opposite to the upper housing body, the housing is a metal housing, and the adhesion layer adheres the electrode assembly to the housing.

12. The secondary battery according to claim 11, wherein the adhesion layer is further provided on a surface of an inner side wall of the recess.

13. The secondary battery according to claim 11, wherein the upper housing body is plate-shaped, and the adhesion layer is further provided on an inner surface of the upper housing body.

14. The secondary battery according to claim 13, wherein when viewed from a thickness direction of the secondary battery, a distance from an edge of the adhesion layer to a corresponding outer side edge of the upper housing body or the lower housing body is 6 mm to 10 mm.

15. The secondary battery according to claim 11, wherein the adhesion layer comprises an aqueous binder; and
the aqueous binder comprises a copolymer of a first monomer and a second monomer, wherein the first monomer comprises at least one of ethyl methacrylate, butyl acrylate, or 2-ethylhexyl acrylate; and the second monomer comprises at least one of styrene, acrylonitrile, or vinyl acetate.

16. The secondary battery according to claim 15, wherein a mass ratio of the first monomer to the second monomer is 1:1.0 to 1:1.5.

17. The secondary battery according to claim 15, wherein the adhesion layer further comprises an additive; and the additive comprises at least one of a plasticizer, a thickener, or a dispersant.

18. The secondary battery according to claim 11, wherein the adhesion layer comprises an oily binder; and the oily binder comprises at least one of polyacrylic acid, polyvinylidene fluoride, polymethyl acrylate, polyethylene acrylate, poly-2-methyl methacrylate, poly-2-ethyl methacrylate, styrene acrylate copolymer, polyacrylonitrile, polyacrylamide, polyimide, or polyamide.

19. The secondary battery according to claim 11, wherein a thickness of the adhesion layer is 5 μm to 20 μm.

20. The secondary battery according to claim 11, wherein an adhesion force of the adhesion layer after soaking in a test electrolyte is 50 N/m to 200 N/m.
